(19) United States
(12) Patent Application Publication
(10) Pub. No.: US 2006/0143637 A1
(43) Pub. Date: Jun. 29, 2006

(54) Optical disk device and optical component used therein

(75) Inventor: Shinnosuke Torii, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/288,091

(22) Filed: Nov. 29, 2005

(30) Foreign Application Priority Data
Dec. 1, 2004 (JP) 2004-348550

(51) Int. Cl. G11B 7/085; G11B 7/08; G11B 7/09

(52) U.S. Cl. 720/660

(57) ABSTRACT

An optical disk device is provided which can realize size and cost reduction and which includes: an optical pick-up; a drive source; a drive member for moving the optical pick-up by utilization of a drive force generated by the drive source; and a striking member for striking against the drive member, wherein abutment between the striking member and the drive member results in loss of synchronism of the drive source and a predetermined position of the drive member is determined. An optical component for use in the optical disk device is also provided.

### BACKGROUND OF THE INVENTION

1. Field of the Invention

The present invention relates to an optical disk device using, for example, CD, DVD, MD, or Blu-ray Disc, and an optical component used in such a device.

2. Related Background Art

In recent years, in the field of an optical disk device, in order to attain a higher density, study of technology for decrease of wavelength of a light source and for increase of NA of an objective lens has been extensively conducted.

Further, in some fields, a device using a 405 nm semiconductor laser and an objective lens of NA=0.85 has begun to be commercially manufactured.

In a case where a short wavelength light source and an objective lens of a high NA are used, there remain the following basic problems.
(1) Being susceptible to tilt of disk
(2) Being susceptible to thickness error of transparent substrate
(3) Being susceptible to wavelength hop of light source

Of the above problems, the problem (1) has been solved by using a transparent substrate of a small thickness. For example, a transparent substrate of about 100 μm thickness is used.

The problems (2) and (3) are attempted to be solved by appropriately designing an optical system.

For example, the problem (3) derived from a wavelength hop of a light source is attempted to be solved by additionally providing a chromatic aberration correcting lens which generates a chromatic aberration to cancel a chromatic aberration generated in an objective lens.

With respect to the problem (2), various techniques have been considered which include, for example, (a) a technique in which a spherical aberration generated when an error generates in the thickness of a transparent substrate is cancelled by additionally providing a beam expander and changing a lens spacing to generate a spherical aberration, and (b) a technique in which a position of a collimator lens is changed in an optical axis direction to generate a spherical aberration, thereby canceling a spherical aberration derived from a thickness error of a transparent substrate.

Such techniques are disclosed in, for example, Japanese Patent Application Laid-Open No. 2002-236252.

To briefly describe, in the case where a beam expander is used, as shown in FIG. 11A, in a parallel light flux at an incidence side of an objective lens 45, there is provided an expander 43 consisting of a lens 41 having negative power and a lens 42 having positive power, and the distance between the lens 41 and the lens 42 is changed depending on a thickness error of a transparent substrate to generate a spherical aberration.

Further, in the case where the position of a collimator lens is changed, with a system as shown in FIG. 11B, a collimator lens 44 is moved depending on a thickness error of a transparent substrate along an optical axis to generate a spherical aberration.

Further, in order to realize such a movable optical system, it is necessary to accurately set a reference position of an optical component in connection with other components.

Hence, in general, as means for detecting a reference position, an output signal of a position detecting means of a drive member such as a sensor is used.

Such a technique is disclosed in, for example, Japanese Patent Application Laid-Open No. 2003-131113.

A brief description will be made with reference to FIG. 1 (shown in FIG. 12 of the attached drawings) and FIG. 5 (shown in FIG. 13 of the attached drawings) of Japanese Patent Application Laid-Open No. 2003-131113 above.

A spherical aberration correcting device 10 is consisting of a holder 11 that holds a convex lens 12 and a holder 13 that holds a concave lens 14, and the holder 11 of the convex lens 12 is fixed to an unillustrated OP base of the device.

The holder 13 of the concave lens 14 is fixed to a holder driving rack 15, which has a light-shielding member 16 reciprocatable in a predetermined direction fixed thereto, and the other end portion of which is engaged with a lead screw 19 that is a rotation shaft of a stepping motor 17.

With the rotation of the stepping motor 17, and by the engagement with the lead screw 19, the holder driving rack 15 reciprocates in a direction shown by an arrow d, and in order to accurately perform the reciprocation in the direction d, a guide shaft 20 is provided.

The light-shielding member 16 forms a light-shielding body 16a which can move in and out of a photosensor 30, and a top end portion of which is located within a U-shaped package of the photosensor 30.

Further, both end portions of the lead screw 19 are rotatably borne by an angle 18.

The angle 18 is fixed to the unillustrated OP base.

In one wall of the package 31 is mounted a light emitting member 33, and in the other wall is mounted a light receiving member 34.

Further, the lower surface of the package 31 is integrally formed with pin portions 32 (each with a screw formed at a lower end thereof) to be inserted into long holes formed in the unillustrated OP base, and is constituted so as to be fixed to the OP base at a location where the reference position is adjusted.

With the above described configuration, an output of the photosensor 30 is detected, and the reference position of the concave lens 14 is determined.

In this configuration, an output in a state in which the light shielding body 16a completely shields the light receiving portion is defined as 0, and a position corresponding to L₂′, which is a half of an output L₂ when the light-shielding body 16a completely moves out of the light receiving portion, is defined as a reference position.

Further, also in the conventional optical disk device, a position detecting means has been provided.

Detailed description will be made below with reference to FIG. 14.

An optical disk device 51 is composed of a chassis 52 as a structural base; a spindle motor 53 provided in the chassis 52, for mounting and rotating a disk (not shown); an optical pick-up 54; an objective lens 55 provided in the optical pick-up 54, for irradiating a light beam; a feed motor 56 (a stepping motor) provided in the chassis 52 and having a lead screw 58 for moving the optical pick-up 54 in a radial direction of the disk; and a guide shaft 57 for support the optical pick-up 54.

Thus, the disk rotated by the spindle motor 53 is irradiated with an optical beam from the objective lens 55 of the optical pick-up 54.

Further, the lead screw 58 integrally formed with a rotation shaft of the feed motor 56 and the optical pick-up 54 mesh with each other through an unillustrated rack, and by converting the rotational motion of the lead screw 58 to translational motion, the optical pick 54 moves in a radial direction of the disk with the guide shaft 57 being used as a guide.

Thus, the optical disk device 51 records or reproduces an information on or from the disk.

Further, at a portion of the chassis 52 on a disk outermost periphery side, there is provided a position detecting sensor 59 of contact-type, and the optical pick-up 54 moves to the disk outermost periphery side to abut against the position detecting sensor 59, thereby performing the reference position detection.

In this case, in addition to a required movable range (a movable range in which the objective lens 55 can access from an innermost periphery to an outermost periphery of the disk in the case of this prior art example), an overrun amount until when detected by the position detecting sensor 59 is required.

Incidentally, although in the above-mentioned prior art example, the position detecting sensor 59 is provided at the outermost periphery portion, it may be provided at an innermost periphery portion.

Further, in the above-mentioned optical disk device, the reference position detected by the position detecting sensor 59 is utilized as a home position in OFF state of a power supply of the optical disk device.

For example, in a case of a disk medium so preformatted as to always access the innermost periphery of the disk at the time of activation, by locating the optical pick-up at a reference position at a disk innermost periphery side, the time required for transporting the optical pick-up after the power supply has been turned on is shortened.

The operation of the optical pick-up 54 in OFF state of the power supply in this case will be described in detail with reference to FIG. 15.

When an operator turns off the power supply switch, the optical pick-up 54 moves toward the position detecting sensor 59 (toward the outer periphery of the disk in this prior art example).

After that, the optical pick 54 is detected by abutting against the position detecting sensor 59, and by this detection signal, the optical pick-up 54 stops moving, and then the power supply of the device body is turned off.

Further, examples of other applications than the above described include reference position detection for prevention of collision of an optical pick-up against a chassis body or spindle motor.

As described in detail above, in a driving mechanism of the conventional optical component or product mounted with an optical component such as an optical disk device, any position detecting means is generally used.

In recent years, for such optical component or product mounted with an optical component such as an optical disk device, size and cost reduction of the device have been required.

However, when the above described position detecting sensor as position detecting means is used, there are posed the problems such as device size increase for providing disposition space thereof and cost increase due to increase of the number of parts.

For example, when a position detecting sensor is used, and when an approximate center position of a movable range is set as a reference position as with the technique disclosed in Japanese Patent Application Laid-Open No. 2003-131113, a light-shielding member (light-shielding body 16a) of the position detecting sensor requires a length more than half the movable range because of its structure, thereby contributing to increase of the device size.

Further, as also disclosed in Japanese Patent Application Laid-Open No. 2003-131113, in order to determine a reference position, it is firstly necessary to adjust an original position of a photosensor at a manufacturing factory, which contributes to cost increase.

Incidentally, in the case of the structure in which position detection is performed by a position detecting sensor of contact-type at an end portion of a movable range, it is easy to obtain position precision of the sensor as compared to a non-contact-type sensor.

This is because it is easy to determine the position in accordance with a part position, such as abutment through striking of a detected part against a detection means or the like and further because detection through contact makes it difficult to be affected by a temperature change.

However, there will be an amount of overrun that the optical pick-up will make before the reference position is detected, at an end portion of the movable range, which contributes to increase of the device size.

This overrun amount is necessary to surely secure the movable range in consideration of a tolerance and the like, and is determined by adding to a tolerance of parts to determine the movable range, a detection tolerance of the sensor, a stopping distance required from detection to actual stopping, and a margin.

Further, in the case of the position detecting sensor of contact-type, there is mentioned the problem of shock (or impact) and vibration at the time of contact.

Particularly, in an optical disk device of the recent years that performs high-density recording/reproducing, extremely high precision is required for optical components constituting the device.

Under such circumstances, avoidance of the disturbance such as shock, vibration and the like which may contribute to an error has been required.

### SUMMARY OF THE INVENTION

It is, therefore, an object of the present invention to provide an optical disk device and an optical component used in the device that can realize size and cost reduction of the device.

To achieve the above object, according to one aspect of the present invention, there is provided an optical disk device comprising:

an optical pick-up;

a drive source;

a drive member for moving the optical pick-up by utilization of a drive force generated by the drive source; and

a striking member for striking against the drive member,

wherein abutment between the striking member and the drive member results in loss of synchronism of the drive source and a predetermined position of the drive member is determined.

According to another aspect of the present invention, there is provided an optical component for use in an optical disk device comprising:

a drive source;

a drive member for moving an optical component by utilization of a drive force of the drive source; and

a striking member for striking against the drive member,

wherein abutment of the striking member and the drive member results in loss of synchronism of the drive source and a predetermined position of the drive member is determined.

### BRIEF DESCRIPTION OF THE DRAWINGS

FIG. 1 is a block diagram showing an optical system of an optical pick-up device in accordance with the present invention;

FIG. 2 is a graphical representation showing a relation between a thickness error of a transparent substrate and a distance between lens groups to correct the error in a case where a first lens group is moved;

FIG. 3 is a graphical representation showing a relation between a thickness error of a transparent substrate and a distance between lens groups to correct the error in a case where a second lens group is moved;

FIGS. 4A, 4B, and 4C are schematic perspective views showing a spherical aberration correcting mechanism in accordance with the present invention;

FIG. 5A is a schematic perspective view showing a first support member and a second support member shown in FIGS. 4A, 4B, and 4C, and FIG. 5B is a cross-sectional view taken along line 5B-5B of FIG. 5A;

FIG. 6A is a schematic perspective view showing structures of a stepping motor 25 and a nut member 21 shown in FIGS. 4A, 4B, and 4C, and FIG. 6B is a cross-sectional view taken along line 6B-6B of FIG. 6A;

FIG. 7 is a schematic diagram showing driving parameters of a first embodiment;

FIGS. 8A and 8B are schematic diagrams showing the effect of size reduction of a device in accordance with the first embodiment;

FIGS. 9A, 9B, and 9C are views of an optical disk device of a second embodiment;

FIG. 10 is a flowchart showing the operation of an optical pick-up in OFF state of a power supply of the second embodiment;

FIGS. 11A and 11B are diagrams showing an outline of a first prior art example;

FIG. 12 is a view showing an outline of the first prior art example;

FIG. 13 is a graphical representation showing an outline of the first conventional example;

FIG. 14 is a view showing an optical disk device of a second prior art example; and

FIG. 15 is a flowchart showing the operation of an optical pick-up in OFF state of a power supply of the second prior art example.

### DESCRIPTION OF THE PREFERRED EMBODIMENT

Preferred embodiments of the present invention will be described below with reference to the drawings.

### First Embodiment

A first embodiment of the present invention will be shown below. The first embodiment shows a case where the present invention is applied to a spherical aberration correcting mechanism of an optical pick-up.

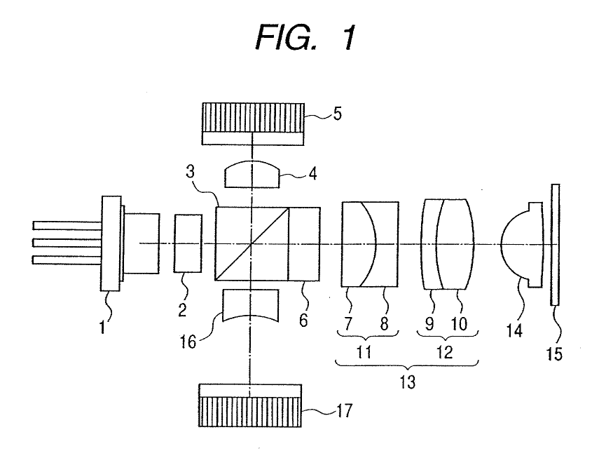

FIG. 1 is a schematic diagram of an optical system of an optical pick-up device in accordance with the present embodiment.

A beam emitted from a semiconductor laser 1 is split into a main beam and two subbeams by a diffraction grating 2.

The subbeams are used for generation of a servo signal for DPP (differential push-pull) detection.

The beams from the diffraction grating are partially reflected by a PBS 3 and converged into a monitor PD 5 by a condenser lens 4.

An output of the monitor PD is used for controlling the emission power of the semiconductor laser 1.

The beams transmitted through the PBS 3 is made parallel light flux by a collimator lens 13 as a lens unit through a λ/4 plate 6, and forms an image on an information recording surface by an objective lens 14 through a transparent substrate.

Here, the optical disk 15 is formed of the transparent substrate and the information recording surface.

The beams reflected by the optical disk 15 is converged by the objective lens 14, and is reflected by the PBS 3 through the collimator lens 13 and the λ/4 plate 6, and is then converged onto a RF servo PD 17 by a sensor lens 16.

By an output from the RF servo PD 17, an information signal and a servo signal are obtained.

Here, the wavelength of the semiconductor laser 1 is approximately 407 nm at the time of information reproduction, and the NA and focal length of the objective lens 14 are 0.85 and 1.1765 mm, respectively.

Designed values of a projection system of the present embodiment are shown in Table 1.

In Table 1, N (407) represents a refractive index at a wavelength of 407 nm, ΔN represents a change in refractive index when the wavelength is increased by 1 nm and corresponds to the dispersion in the vicinity of the wavelength of 407 nm.

The aspherical shape is represented by Equation 1:

$$X = \frac{{h}^{2} / r}{1 + \sqrt{1 - ( 1 + k ) {h}^{2} / {r}^{2}}} + {Bh}^{4} + {Ch}^{6} + {Dh}^{8} + {Eh}^{10} + {Fh}^{12} + {Gh}^{14}$$

wherein X is a distance in the optical axis direction; h is a height in a direction perpendicular to the optical axis; and k is a conical coefficient, and is shown in Table 2.

TABLE 1

| | Remarks | r | d | N(407) | ΔN |
|---|---|---|---|---|---|
| 1 | LD | ∞ | 0.78 | | |
| 2 | | ∞ | 0.25 | 1.52947 | −0.00008 |
| 3 | | ∞ | 1.19 | | |
| 4 | Diffraction | ∞ | 1 | 1.52947 | −0.00008 |
| 5 | grating | ∞ | 1.6 | | |
| 6 | PBS | ∞ | 2.6 | 1.72840 | −0.00042 |
| 7 | λ/4 plate | ∞ | 1.15 | 1.56020 | −0.00020 |
| 8 | | ∞ | 1.46 | | |
| 9 | Collimator | ∞ | 1.29 | 1.58345 | −0.00014 |
| 10 | | −2.28 | 0.71 | 1.80480 | −0.00053 |
| 11 | | ∞ | 0.8 | | |
| 12 | | 13.49 | 0.74 | 1.80480 | −0.00053 |
| 13 | | 4.967 | 1.26 | 1.58345 | −0.00014 |
| 14 | | −4.411 | 6.5 | | |
| 15 | Objective | 0.89427 | 1.57 | 1.70930 | −0.00021 |
| (Aspherical | lens | | | | |
| lens 1) | | | | | |
| 16 | | −3.38795 | 0.27 | | |
| (Aspherical | | | | | |
| lens 2) | | | | | |
| 17 | Transparent | ∞ | 0.08 | 1.62068 | −0.00038 |
| 18 | substrate | ∞ | 0 | | |

TABLE 2

| Aspherical | Aspherical | Aspherical |
|---|---|---|
| coefficient | lens 1 | lens 2 |
| k | −4.71569E−01 | −8.03122E+02 |
| B | 1.85624E−02 | 6.93685E−01 |
| C | −3.32437E−03 | −7.23881E−01 |
| D | 2.00843E−02 | −1.08028E+01 |
| E | −2.46799E−02 | 5.02375E+01 |
| F | 3.71610E−02 | −6.88792E+01 |
| G | −2.00730E−02 | 0 |

As can be seen from Table 1, the collimator lens 13 is composed of the spherical lenses only, and is an optical element which can easily be produced and is inexpensive.

Here, a case where a thickness error is generated in the transparent substrate of the optical disk 15 will be described.

In a case where a thickness error is generated in the transparent substrate, a spherical aberration is generated as well known. Especially when a short-wavelength light source and a high-NA objective lens are used, the influence of the spherical aberration is great.

Therefore, in the optical system of the present embodiment, by changing a distance between a first lens group 11 constituted by a lens 7 and a lens 8 of the collimator lens 13, which is a lens unit, and a second lens group 12 constituted by a lens 9 and a lens 10, the generated spherical aberration is corrected.

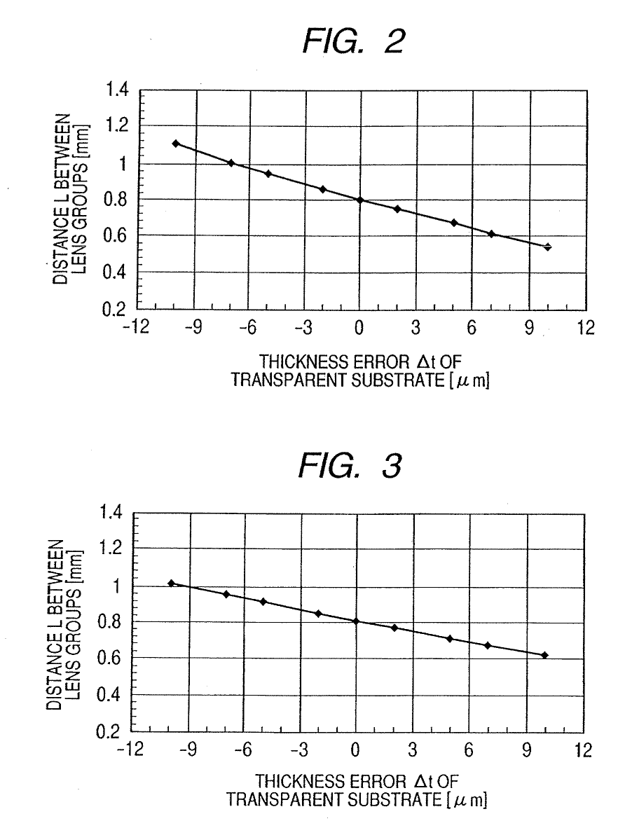

In each of FIGS. 2 and 3 is shown a relation between the thickness error of the transparent substrate and the distance between the lens groups to correct the error.

FIG. 2 shows a case where the first lens group 11 is moved with the second lens group 12 being fixed.

The moving amount per 1 μm of the transparent substrate thickness error is approximately 28 μm.

Further, FIG. 3 shows a case where the second lens group 12 is moved. In this case, the moving amount per 1 μm of the transparent substrate thickness error is approximately 20 μm.

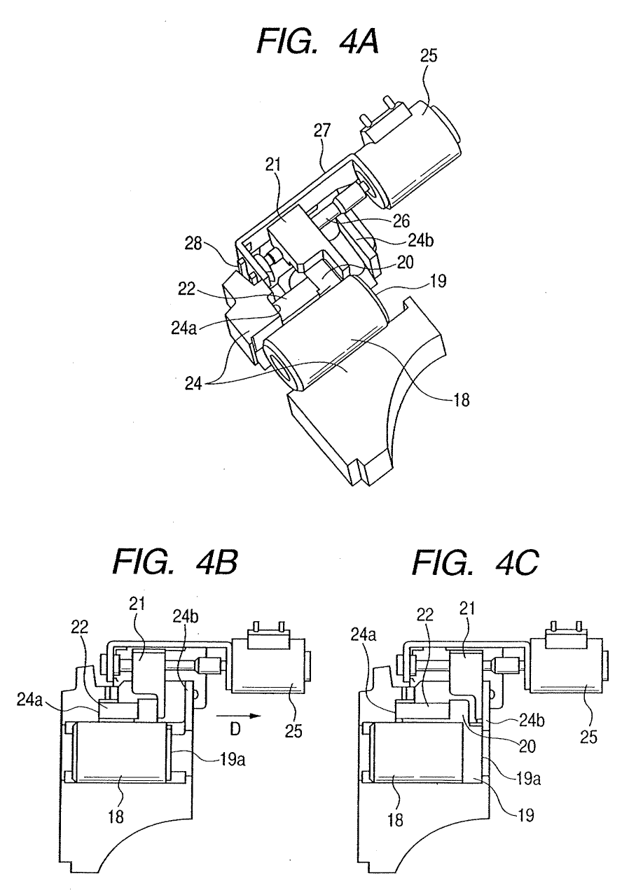

FIGS. 4A, 4B, and 4C are schematic views of a spherical aberration correcting mechanism in accordance with the present invention.

Specifically, FIG. 4A is a schematic perspective view, FIG. 4B shows a state in which a drive member and a driven member to be described later are in contact with each other, and FIG. 4C shows a state in which the drive member and the driven member are not in contact.

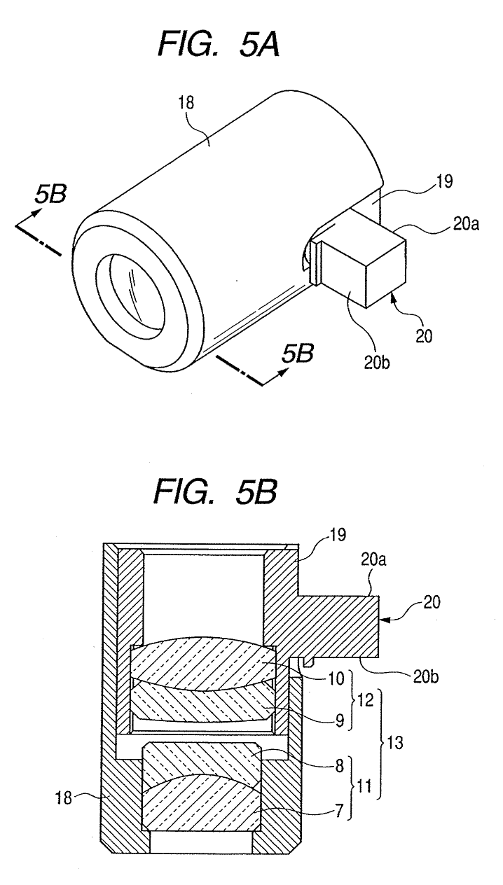

FIG. 5A is a perspective view showing a first support member 18 and a second support member 19 to be described later, and in FIG. 5B is a cross-sectional view taken along line 5B to 5B of FIG. 5A.

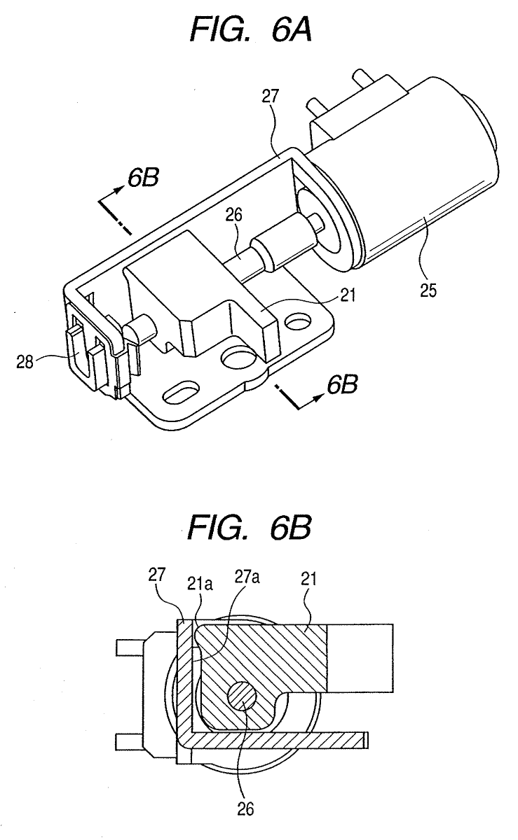

Further, FIG. 6A is a schematic perspective view showing the structure of a stepping motor 25 and a nut member 21 to be described later, and FIG. 6B is a cross-sectional view taken along line 6B to 6B of FIG. 6A.

Reference numeral 18 denotes a first support member to support the first lens group 11, and reference numeral 19 denotes a second support member to support the second lens group 12, and each lens group is fixed to each support member.

Incidentally, in the present embodiment, the first lens group 11 is a fixed lens group while the second lens group 12 is a movable lens group, and the first support member 18 for supporting the fixed lens group is adhered and fixed to an optical base 24 (only a portion necessary to describe the present embodiment is illustrated in the figures).

In the present embodiment, each support member has a substantially cylindrical shape which is coaxial with the corresponding lens group, and the second support member 19 is slidably inserted into the first support member 18.

Further, a protruding portion 20 is integrally provided at a part of the second support member 19, and a nut member 21 is abutted against an end face 20a of the protruding portion 20.

On the other hand, a coil spring 22 is abutted against an end face 20b opposing to the end face 20a, and the coil spring 22 is provided while being urged between the end face 20b and a coil receiving portion 24a of the optical base.

Further, reference numeral 25 denotes a stepping motor which is a drive source, and a lead screw 26 is integrally formed with a rotation shaft of the stepping motor 25.

Reference numeral 27 denotes an angle member fixed to the stepping motor 25, and a bearing part 28 of the lead screw 26 is provided.

As shown in FIGS. 6A and 6B, the lead screw 26 is engaged with the nut member 21, and by the abutment of an end face 27a of the angle member 27 against an abutting portion 21a of the nut member 21, the nut member 21 is slidable without being rotated in the direction of the rotation axis of the lead screw 26.

Incidentally, in the present invention, the stepping motor 25 is regarded as a drive source, the nut member 21 as a drive member, and the second support member 19 as a driven member.

Next, the operation will be described in detail.

In a case where the drive member and the driven member are in contact with each other as shown in FIG. 4B, the second support member 19, which is the driven member, is held by the nut member 21, which is the drive member, and by the urging force of the coil spring 22, thereby adjusting the lens spacing.

Further, by moving the nut member 21 in a direction shown by an arrow D, the second support member 19 is similarly moved in the direction of the arrow D by the urging force of the coil spring 22.

Thereby, firstly, an end face 19a of the second support member 19 abuts against a stopper portion 24b of the optical base.

After that, by moving the nut member 21 further in the direction of the arrow D, the drive member and the driven member are brought into a non-contact state.

Further, as shown in FIG. 4C, by moving the nut member 21 further in the direction of the arrow D, the nut member 21 abuts against the stopper portion 24b of the optical base 24, and this abutting position is defined as a reference position in accordance with the present invention.

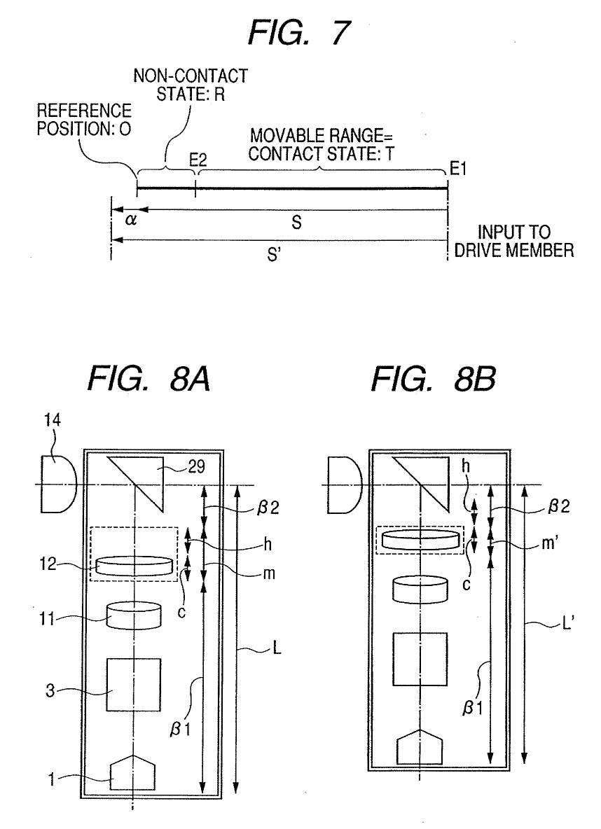

FIG. 7 shows driving parameters of the drive member.

In the figure, 0 denotes a reference position; E1 and E2 denote end points of a movable range (E1 being more apart from the point O); T denotes the distance between E1 and E2 in which the drive member and the driven member are in contact state; and R denotes the distance between O to E2 in which the drive member and the driven member are in non-contact state.

Thus, a distance S of the movement from the most distant point E1 of the movable range to the reference position can be represented by S=T+R.

Here, when the nut member 21 is located at the most distant point E1 of the movable range, an input is given in such a manner as to move the nut member 21 by the distance represented by S+arbitrary movable amount α=S1.

In this manner, when pulses of a number which can perform movement by the distance S1=S+α, is inputted into the stepping motor, the nut member 21, independently of its location between the reference position O and the end point E1 of the movable range, abuts against the stopper portion 24b, and the stepping motor 25 loses synchronism, so that the nut member 21 inevitably stops moving at the reference position O.

After that, by applying input pulses of a number corresponding to the distance to the target point, the nut member 21 is moved to the target position, so that the position adjustment of the second support member 19 as the driven member (i.e., adjustment of lens spacing) is performed.

Incidentally, the adjustment method of the lens position is the same as described for the prior art example. Specifically, after the reference position has been determined, the nut member is moved to, for example, the center position of the movable range, and an arithmetic operation for spherical aberration correction is performed by an unillustrated control device, and the stepping motor 25 is driven again, and then, the nut member is stopped moving at a position where the spherical aberration is corrected.

At this time, the distance to the center position of the movable range taken as the target value may be determined from, for example, the designed value and the like, and the parameters of the adjustment result after the adjustment has been made once based on the designed value may be also used.

Of course, when abutted against the reference position, since the drive member and the driven member are in non-contact state, avoidance of shock and vibration to the optical parts such as lens or the like due to the loss of synchronism is also realized.

Further, the effect of size reduction by the present invention will be described below with reference to FIGS. 8A and 8B.

FIGS. 8A and 8B are views each showing a part of an optical system to explain the effect of the size reduction, and FIG. 8A shows a prior art example while FIG. 8B shows the present embodiment.

For clarity, the same numerals are employed in the figures as are employed in FIG. 1 for equivalent parts, and reference numeral 29 denotes a deflection mirror to irradiate a disk surface perpendicularly with a beam.

In FIGS. 8A and 8B, the driven member is the second lens group 12.

In the figures, reference character c denotes a movable range necessary for the driven member, and reference character h denotes an overrun amount required for the detection by a position detecting means (not shown) such as a sensor of the prior art example as described above, and it is assumed that also in the embodiment shown in FIG. 8B, movement of the same distance as above is performed until the loss of synchronism.

However, it is possible to perform size reduction at least by an amount corresponding to the stopping distance required from detection by the detection means to stopping.

Further, reference character m denotes a motion range of the driven member calculated by c+h, reference character β1 denotes the length of an optical path formed by optical elements fixed to the optical base between the semiconductor laser 1 and the first lens group 11, reference numeral β2 denotes the length of an optical path formed by the deflection mirror 29 fixed to the optical base between the second lens group 12 and the objective lens 14, and reference character L denotes the entire optical path length calculated by m+B1+B2.

Here, the reason why the attention is paid to the entire optical path length is that in a unit mounted with an optical element such as an optical pick-up, the optical path length of the optical element group becomes a parameter to determine the size of the device.

Thus, in the prior art example, at least a length L determined by adding the motion range m of the driven member to B1+B2 is required.

In contrast to this, in the present embodiment, since it is possible to perform the movement with the drive member being in non-contact with the driven member, the overrun mount can be disposed, for example, within the range of β2 (c corresponding to T in FIG. 7 and h corresponding to R in FIG. 7).

Hence, the motion range m′ of the driven member (the second lens group 12) remains to be the required movable range c, and the entire optical path length L′ of the present embodiment can be reduced by the overrun amount h than the prior art example, so that the size reduction of the device can be realized.

Of course, when compared to the prior art example, since a sensor becomes unnecessary, size and cost reduction of the device just by the space required for the provision of a sensor can be realized.

Incidentally, in the embodiment shown in FIGS. 4A to 4C, the overrun amount h is disposed at a position which is offset in the radial direction of the disk with respect to the optical axis, thereby obtaining the effect of the present invention.

### Second Embodiment

A second embodiment of the present invention will be described below. The second embodiment shows a case where the present invention is applied to an optical pick-up moving mechanism of an optical disk device.

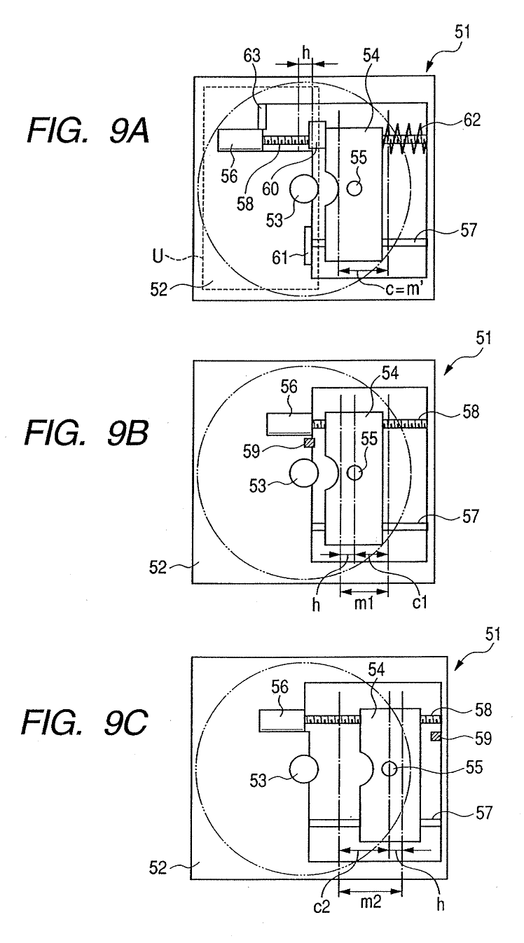

FIGS. 9A, 9B, and 9C are schematic views each showing an optical disk device, and FIG. 9A shows the present embodiment, FIG. 9B shows a conventional example in which a position detecting sensor 59 to be described later is provided on a disk inner periphery side, and FIG. 9C shows a conventional example in which a position detecting sensor 59 is provided on a disk outer periphery side.

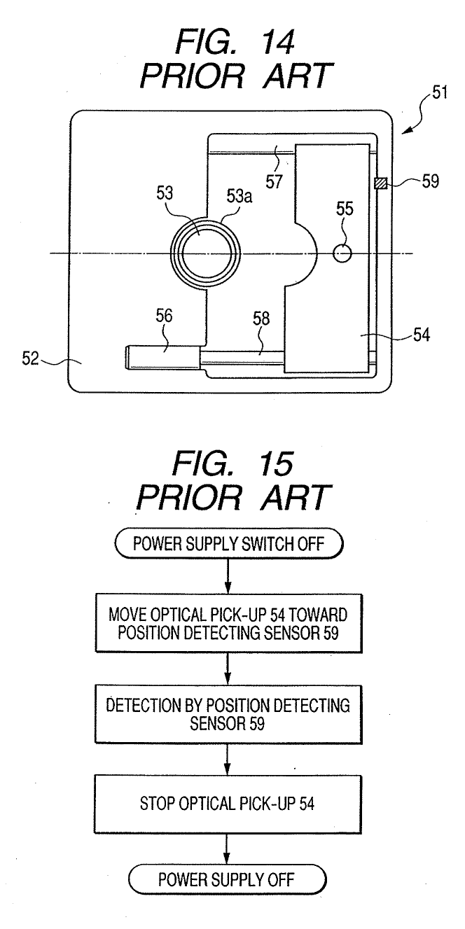

The basic structure of the present optical disk device is the same as the prior art example shown in FIG. 14, and like numerals denote like parts.

In FIGS. 9A, 9B, and 9C, a two-dot chain line shows a disk-shaped recording medium in which an information is recorded/reproduced.

Further, reference numeral 60 denotes a nut member which is a drive member, reference numeral 61 denotes a stopper portion of an optical pick-up 54 integrally formed with a chassis 52, reference numeral 62 denotes a coil spring to press the optical pick-up 54 to the nut member 60, and reference numeral 63 denotes a nut abutting portion integrally formed with the chassis 52.

Further, the nut member 60 is formed with a rotation stopper by an unillustrated method, and is constituted to be movable in the radial direction of the disk by the rotation of a feed motor 56 which is a drive source.

Moreover, the optical pick-up 54 corresponds to the driven member in accordance with the present invention, and is constituted to be slidable relative to each of a guide shaft 57 and a lead screw 58.

In the present embodiment, the coil spring 62 is provided so as to contain the lead screw 58 therein such that one end thereof urges a side surface of the optical pick-up 54 and the other end abuts against an end face of the unillustrated chassis 52.

Reference character c in the figures denotes a distance by which the objective lens 55 is moved by a feed motor 56 in order to access from the innermost periphery to the outermost periphery of the disk, and reference character h denotes an overrun amount.

Incidentally, in the present embodiment, the overrun amount is taken as h similarly to the above described prior art example, and in FIG. 9A, it is shown as a moving distance of a surface abutting against the optical pick 54 of the nut member 60.

The driving parameters of the drive member of the present embodiment are the same as the first embodiment, and the description thereof will be therefore omitted.

That is, the reference position O in FIG. 7 described in the first embodiment corresponds to a state in which the nut member 60 abuts against the nut abutting portion 63, and the distance R in non-contact state corresponds to h in the figures, and the distance T in contact state corresponds to c in the figures.

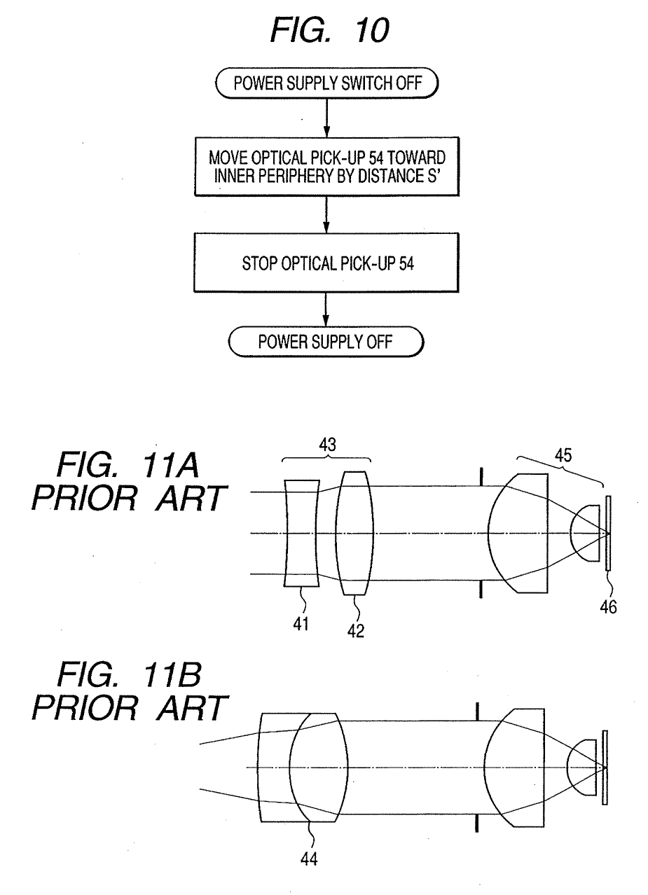

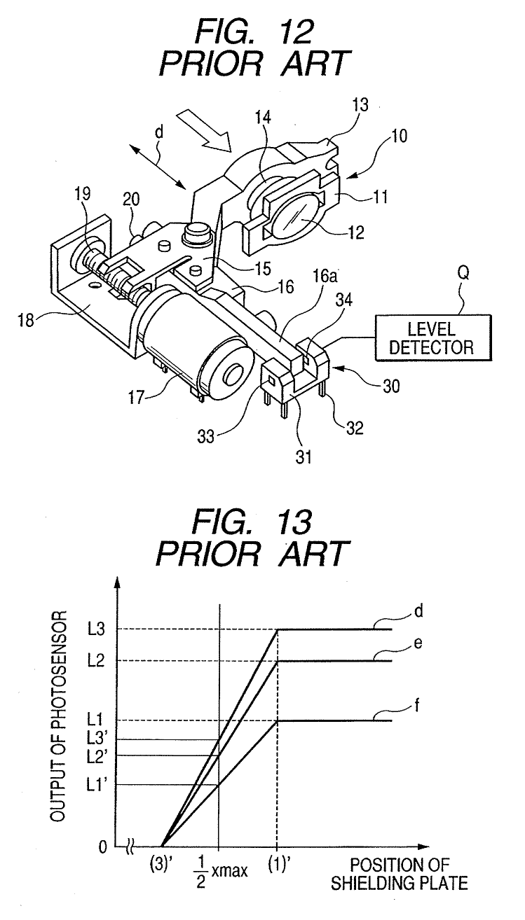

Next, the moving operation of the optical pick-up 54 to the reference position in OFF state of the power supply will be described with reference to FIG. 10.

In a case where the power supply switch is turned off by an operator, the feed motor 56, which is a stepping motor, is rotated in such a direction as to allow the optical pick-up 54 to approach the reference position by applying pulses of a number corresponding to the distance S′ shown in FIG. 7.

Thereby, by the nut member 60 and the coil spring 62, the optical pick-up 54 is moved and abuts against the stopper portion 61, and the nut member 60 then abuts against the nut abutting portion 63 to lose synchronism.

After movement by the pulses of the number corresponding to the distance S′, the feed motor 56 stops rotating, and after that, the power supply of the device body is turned off.

Next, the effect of size reduction in accordance with the present invention will be described.

As is seen from FIGS. 9B and 9C, in the conventional examples, the optical pick 54 is required to move by the distance m1 (=c1+h) or m2 (=c2+h) obtained by adding the overrun amount h to the access movement distance c from the innermost periphery to the outermost periphery of the optical pick-up 54.

Here, as shown in FIG. 9B, in a case where the position detecting sensor 59 is provided at the inner periphery side, there is required a device structure in which the optical pick-up 54 is further movable to the disk inner periphery side by the overrun amount h.

However, with such a structure, since the optical pick-up 54 and the spindle motor 53 interfere with each other, there arises a problem that the recording region on the disk inner peripheral side is reduced by the overrun amount h.

That is, as shown in FIG. 9B, although the moving amount m1 of the optical pick-up 54 can be constituted so as to be the same as the moving amount m′ of the present embodiment shown in FIG. 9A, in that case, there arises a problem that the access movement distance c1 of the optical pick-up 54 (the range in which disk recording can be performed) will become c1<c.

Further, as shown in FIG. 9C, in a case where the position detecting sensor 59 is provided on the disk outer periphery side, there can be adopted such a device structure that the access movement distance c2 of the optical pick 54 becomes c2=c.

However, the moving amount m2 of the optical pick-up 54 becomes a distance including the overrun amount h.

In contrast to this, in the present embodiment shown in FIG. 9A, the moving amount m′ of the optical pick-up 54 consists of only the access movement distance c from the disk innermost periphery to the outermost periphery, so that the size reduction of the chassis 52 which contains the optical pick-up 54 is realized.

Of course, as with the first embodiment, when compared to the prior art example, since a sensor becomes unnecessary, size and cost reduction of the device just by the space required for the provision of a sensor can be realized.

Further, as with the first embodiment, when abutted against the reference position, since the drive member and the driven member are in non-contact state, avoidance of shock and vibration to the optical pick-up 54 due to the loss of synchronism is also realized.

Incidentally, in the present embodiment, the overrun amount h is provided at a position within a region U which is approximately opposite to the region occupied by the optical pick-up 54 with respect to the spindle motor 53.

The reason is that such position is spatial room in an ordinary disk device, and therefore that it is easy to provide the arrangement of the present invention there.

Further, the present invention is not limited to the above described embodiments and can also be applied to, for example, the expander mechanism shown in the prior art example.

Further, although in the first embodiment, the state R of non-contact of the drive member and the driven member is formed on the side of the optical path length β2 constituted by the deflection mirror 29, it may be formed on the β1 side.

Further, although in the second embodiment, the overrun amount h is disposed on the disk inner periphery side, it is naturally possible to dispose it on the outer periphery side.

This application claims priority from Japanese Patent Application No. 2004-348550 filed on Dec. 1, 2004, which is hereby incorporated by reference herein.

What is claimed is:

1. An optical disk device comprising:
an optical pick-up;
a drive source;
a drive member for moving the optical pick-up by utilization of a drive force generated by the drive source; and
a striking member for striking against the drive member,
wherein abutment between the striking member and the drive member results in loss of synchronism of the drive source and a predetermined position of the drive member is determined.

2. The optical disk device according to claim 1, wherein the drive source is a stepping motor.

3. An optical component for use in an optical disk device comprising:
a drive source;
a drive member for moving an optical component by utilization of a drive force of the drive source; and
a striking member for striking against the drive member,
wherein abutment of the striking member and the drive member results in loss of synchronism of the drive source and a predetermined position of the drive member is determined.

4. The optical component according to claim 3, wherein the drive source is a stepping motor.

5. The optical component according to claim 3, which is an expander lens for spherical aberration correction.
